(19) United States
(12) Patent Application Publication
(10) Pub. No.: US 2017/0031482 A1
(43) Pub. Date: Feb. 2, 2017

(54) OPTICALLY TRANSPARENT CONDUCTIVE MATERIAL

(71) Applicant: MITSUBISHI PAPER MILLS LIMITED, Sumida-ku, Tokyo (JP)

(72) Inventors: Takenobu Yoshiki, Sumida-ku (JP); Kazuhiko Sunada, Sumida-ku (JP)

(21) Appl. No.: 15/303,605

(22) PCT Filed: Apr. 22, 2015
(86) PCT No.: PCT/JP2015/062231

§ 371 Date: Oct. 12, 2016

(30) Foreign Application Priority Data
Apr. 25, 2014 (JP) 2014-090916

(51) Int. Cl. G06F 3/044

(52) U.S. Cl. CPC G06F 3/044; G06F 2203/04112

(57) ABSTRACT

Provided is an optically transparent conductive material which has a favorably low visibility of moire and grain even when placed over a liquid crystal display and which has an excellent stability of resistance (reliability). An optically transparent conductive material having, on an optically transparent base material, sensor parts electrically connected to terminal parts and dummy parts not electrically connected to the terminal parts, the conductive material being characterized in that in the plane of the optically transparent conductive layer, the sensor parts are formed of a plurality of column electrodes extending in a first direction, the plurality of column electrodes being arranged at an arbitrary cycle in a second direction perpendicular to the first direction in such a manner that each dummy part is sandwiched between every two of the sensor parts, and that the sensor parts and/or the dummy parts are formed of a metal pattern in which a unit pattern area having a specific random mesh pattern is repeated in at least two directions in the plane of the optically transparent conductive layer.

### TECHNICAL FIELD

The present invention relates to an optically transparent conductive material mainly used for touchscreens and, in particular, to an optically transparent conductive material preferably used for optically transparent electrodes of projected capacitive touchscreens.

### BACKGROUND ART

In electronic devices, such as personal digital assistants (PDAs), laptop computers, office automation equipment, medical equipment, and car navigation systems, touchscreens are widely used as their display screens that also serve as input means.

There are a variety of touchscreens that utilize different position detection technologies, such as optical, ultrasonic, surface capacitive, projected capacitive, and resistive technologies. A resistive touchscreen has a configuration in which an optically transparent conductive material and a glass plate with a transparent conductive layer are separated by spacers and face each other. A current is applied to the optically transparent conductive material and the voltage of the glass plate with a transparent conductive layer is measured. In contrast, a capacitive touchscreen has a basic configuration in which a touchsensor formed of an optically transparent electrode is an optically transparent conductive material having a transparent conductive layer provided on a base material. Not having any movable parts, the capacitive touchscreen has high durability and high transmission, and therefore are used in various applications. Further, a touchscreen utilizing projected capacitive technology allows simultaneous multipoint detection, and therefore is widely used for smartphones, tablet PCs, etc.

As an optically transparent conductive material used for touchscreens, those having an optically transparent conductive layer made of an ITO (indium tin oxide) film formed on a base material have been commonly used. However, there has been a problem of low optical transparency due to high refractive index and high surface light reflectivity of ITO conductive films. Another problem is that ITO conductive films have low flexibility and thus are prone to crack when bent, resulting in increased electric resistance of the optically transparent conductive material.

Known as an alternative to an optically transparent conductive material having an ITO conductive film is an optically transparent conductive material having a mesh pattern of a metal thin line on an optically transparent base material, in which pattern, for example, the line width, pitch, pattern shape, etc. are appropriately adjusted. This technology provides an optically transparent conductive material which maintains a high light transmittance and which has a high conductivity. Regarding the mesh pattern formed of metal thin lines (hereinafter written as metal mesh pattern), it is known that a repetition unit of any shape can be used. For example, in Patent Literature 1, a triangle, such as an equilateral triangle, an isosceles triangle, and a right triangle; a quadrangle, such as a square, a rectangle, a rhombus, a parallelogram, and a trapezoid; a (equilateral) n-sidedpolygon, such as a (equilateral) hexagon, a (equilateral) octagon, a (equilateral) dodecagon, and a (equilateral) icosagon; a circle; an ellipse; and a star, and a combinational pattern of two or more thereof are disclosed.

As a method for producing the above-mentioned optically transparent conductive material having a metal mesh pattern, a semi-additive method for forming a metal mesh pattern, the method comprising making a thin catalyst layer on a base material, making a resist pattern on the catalyst layer, making a laminated metal layer in an opening of the resist by plating, and finally removing the resist layer and the base metal protected by the resist layer, is disclosed in, for example, Patent Literature 2 and Patent Literature 3. Also, in recent years, as a method for producing the optically transparent conductive material having a metal mesh pattern, a method in which a silver halide diffusion transfer process is employed using a silver halide photosensitive material as a precursor to a conductive material has been known.

For example, Patent Literature 4, Patent Literature 5, and Patent Literature 6 disclose a technology for forming a metal (silver) mesh pattern by a reaction of a silver halide photosensitive material (a conductive material precursor) having a physical development nucleus layer and a silver halide emulsion layer in this order on a base material with a soluble silver halide forming agent and a reducing agent in an alkaline fluid. This method allows formation of a metal mesh pattern of a uniform line width made of silver, the most conductive metal, and thus the mesh pattern has a thinner line and a higher conductivity as compared with those obtained by other methods. An additional advantage is that a conductive layer having a metal mesh pattern obtained by this method has a higher flexibility, i.e. a longer flexing life as compared with an ITO conductive layer.

In a touchscreen application, an optically transparent conductive material is placed over a liquid crystal display, the cycle of the metal mesh pattern and the cycle of the liquid crystal display element interfere with each other, causing a problem of moire. In recent years, liquid crystal displays having elements of various resolutions are used, which further complicates the problem.

As a solution to this problem, in Patent Literature 7, Patent Literature 8, Patent Literature 9, and Patent Literature 10, a method in which the interference is suppressed by the use of a traditional metal mesh pattern of random shape described in, for example, Non Patent Literature 1 is suggested. In Patent Literature 11, an electrode base material for touchscreens, in which a plurality of unit pattern areas having a random shape metal mesh pattern are arranged is introduced.

### CITATION LIST

### Patent Literature

Patent Literature 1: JP 10-41682 A
Patent Literature 2: JP 2007-287994 A
Patent Literature 3: JP 2007-287953 A
Patent Literature 4: JP 2003-77350 A
Patent Literature 5: JP 2005-250169 A
Patent Literature 6: JP 2007-188655 A
Patent Literature 7: JP 2011-216377 A
Patent Literature 8: JP 2013-37683 A
Patent Literature 9: JP 2014-41589 A
Patent Literature 10: JP-2013-540331 T
Patent Literature 11: JP 2014-26510 A

### Non Patent Literature

Non Patent Literature 1: Mathematical Model of Territories—Introduction to Mathematical Engineering through Voronoi diagrams—(published by Kyoritsu Shuppan in February, 2009)

### SUMMARY OF INVENTION

### Technical Problem

Since the above metal mesh pattern of random shape does not have any cyclic pattern shape formed by repetition of a simple unit graphic and therefore theoretically does not interfere with the cycle of the liquid crystal display element, moire does not occur. However, in the metal mesh pattern, a part where the distribution of the metal thin line is sparse and a part where the distribution is dense randomly appear, which is visibly recognized as a grain-like pattern, causing a problem of so-called “grain”.

In the cases where the optically transparent electrode of a capacitive touchscreen is formed of a metal mesh pattern, a plurality of sensor parts extending in a specific direction are formed of a metal mesh pattern, and are electrically connected with a terminal part via a wiring part. Meanwhile, between the plurality of sensor parts, for the purpose of lowering the visibility of the sensor parts, dummy parts formed of a metal mesh pattern are provided. The metal mesh pattern of the dummy parts has line breaks to avoid electrical connection between separate sensor parts. However, in certain kinds of touchscreens, the width of each sensor part extending in a specific direction is designed so narrow as to be almost equal to the interval between the lines of the metal mesh pattern. In such cases, if the line width of the metal mesh pattern is too thin, the reliability of the optically transparent conductive material may decrease due to the occurrence of changes in the resistance value or line breaks during the processing of the touchscreen or the storage of the optically transparent conductive material having the metal mesh pattern under high-temperature and high-pressure conditions. This problem may be further worsened in the above-mentioned optically transparent conductive material having a random metal mesh pattern. The electrode base material for touchscreens described in the above Patent Literature 11 also has a similar problem regarding the reliability, and has a problem of further worsen visibility of the grain etc. as compared with a non-repetitive pattern.

An object of the present invention is to provide an optically transparent conductive material which is suitable as an optically transparent electrode for capacitive touchscreen, the optically transparent conductive material having a favorably low visibility of moire and grain even when placed over a liquid crystal display and having a high reliability.

### Solution to Problem

According to the present invention, the above object will be basically achieved by (1) an optically transparent conductive material having, on an optically transparent base material, sensor parts electrically connected to terminal parts and dummy parts not electrically connected to the terminal parts, the conductive material being characterized in that in the plane of the optically transparent conductive layer, the sensor parts are formed of a plurality of column electrodes extending in a first direction, the plurality of column electrodes being arranged at an arbitrary cycle in a second direction perpendicular to the first direction in such a manner that each dummy part is sandwiched between every two of the sensor parts, and that the sensor parts and/or the dummy parts are formed of a metal pattern in which a unit pattern area having any of the following mesh patterns (a) to (c) is repeated in at least two directions in the plane of the optically transparent conductive layer.

(a) A mesh pattern consisting of Voronoi edges formed in relation to a plurality of points (generators) arranged in a plane tiled using polygons, the mesh pattern being characterized in that each polygon has only one generator arranged in the polygon, and the generator is at an arbitrary position within a reduced polygon formed by connecting points at 90% of the direct distance from the center of gravity of the polygon to each vertex of the polygon.
(b) A mesh pattern formed by non-periodic tiling of a plane using polygons, the mesh pattern being characterized in that the length of the longest side of all the sides of all the polygons is not more than ⅓ of the cycle of the sensor parts in the second direction.
(c) A mesh pattern obtained by moving 50% or more of all the intersections in an original graphic formed of repetition of an original unit graphic consisting of a polygon (50% or more of all the vertices of the original unit graphics) in a direction, the mesh pattern being characterized in that the distance between the original position of an intersection before the move and the position of the intersection after the move is less than ½ of the distance from the center of gravity of the original unit graphic to the closest vertex of the original unit graphic.
(2) The above object will be achieved by the optically transparent conductive material of the above (1), characterized in that the repetition cycle of the unit pattern area in the second direction is equal to an integral multiple of the column cycle in the second direction, of the column electrodes extending in the first direction; or the column cycle in the second direction, of the column electrodes extending in the first direction is equal to an integral multiple of the repetition cycle of the unit pattern area in the second direction.
(3) The above object will be achieved by the optically transparent conductive material of the above (1) or (2), characterized in that the repetition cycle of the unit pattern area in the first direction is equal to an integral multiple of the pattern cycle in the first direction, of the column electrodes extending in the first direction; or the pattern cycle in the first direction, of the column electrodes extending in the first direction is equal to an integral multiple of the repetition cycle of the unit pattern area in the first direction.

### Advantageous Effects of Invention

The present invention can provide an optically transparent conductive material which has a favorably low visibility of moire and grain even when placed over a liquid crystal display and which has a high reliability.

### BRIEF DESCRIPTION OF DRAWINGS

FIG. 1 is a schematic view showing an example of an optically transparent conductive material.

FIG. 2 is a schematic view for illustrating the mesh pattern of type a.

FIG. 3 is a schematic view for illustrating the mesh pattern of type c.

FIG. 4 is a schematic view for illustrating the unit pattern area.

FIG. 5 is a schematic view of an example of the sensor part and the dummy part of the optically transparent conductive material.

FIG. 6 is a view for illustrating the repetition cycle of the unit pattern area.

FIG. 7 is a view showing the transparent manuscript used for the optically transparent conductive material 1 in the Examples.

FIG. 8 is a view showing the transparent manuscript used for the optically transparent conductive material 2 in the Examples.

FIG. 9 is a view showing the transparent manuscript used for the optically transparent conductive material 3 in the Examples.

### DESCRIPTION OF EMBODIMENTS

Hereinafter, the present invention will be illustrated in detail with reference to drawings, but it is needless to say that the present invention is not limited to the embodiments described below and various alterations and modifications may be made without departing from the technical scope of the invention.

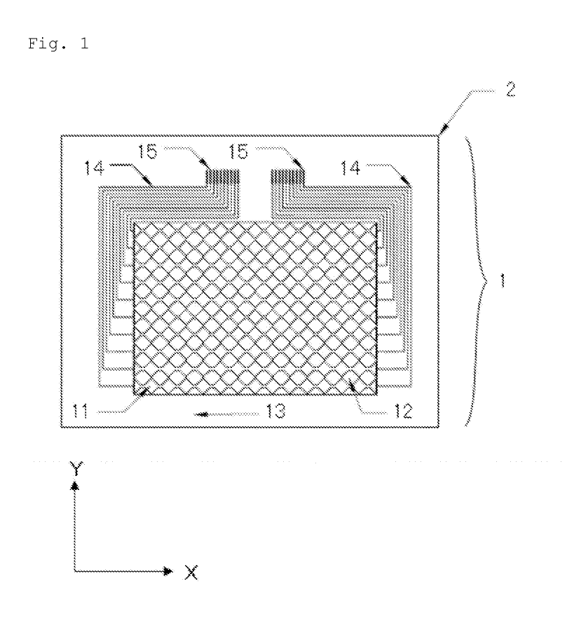

FIG. 1 is a schematic view showing an example of the optically transparent conductive material of the present invention, which is suitable for an optically transparent electrode of projected capacitive touchscreens. In FIG. 1, the optically transparent conductive material 1 has, on at least one side of the optically transparent base material 2, a sensor part 11 formed of a metal mesh pattern, a dummy part 12, a peripheral wiring part 14, a terminal part 15, and a non-image part 13 not having any metal mesh pattern. The sensor part 11 and the dummy part 12 are each formed of a metal mesh pattern (a mesh pattern formed of metal thin lines). In FIG. 1, the boundary between the sensor part and the dummy part is conveniently shown by the outline (non-existent line). The sensor part 11 is electrically connected, via a peripheral wiring part 14, to a terminal part 15. By electrically connecting the terminal part 15 to the outside, the changes in capacitance detected by the sensor part 11 can be captured. In the present invention, the sensor part 11 may be electrically connected by direct contact with the terminal part 15, but is preferably electrically connected with the terminal part 15 via the wiring part 14 as shown in FIG. 1 for assemblage of multiple terminal parts 15. Meanwhile, metal mesh patterns not electrically connected to the terminal part 15 all serve as dummy parts 12 in the present invention. In the present invention, the peripheral wiring part 14 and the terminal part 15 need not particularly have optical transparency, and therefore may either be a solid image (an image without optical transparency) or be provided with optical transparency by the use of a metal mesh pattern as the sensor part 11 and the dummy part 12 are.

In FIG. 1, the sensor parts 11 of the optically transparent conductive material 1 are column electrodes extending in the x direction, and the sensor parts 11 and the dummy parts 12 are arranged in an alternating manner in the y direction (a direction perpendicular to the x direction) in the plane of the optically transparent conductive layer. That is, a plurality of columns of the sensor parts 11 and the dummy parts 12 are arranged in the y direction perpendicular to the x direction in such a manner that each dummy part is sandwiched between two sensor parts, in the plane of the optically transparent conductive layer. In the present invention, as shown in FIG. 1, the sensor parts 11 are arranged at an arbitrary cycle in the y direction. The cycle of the sensor parts 11 in the y direction may be set at an arbitrarily value in the range within which the resolution as a touch sensor is maintained. The width of the sensor part 11 (the length of the sensor part 11 in the y direction in FIG. 1) may be constant, but it is preferred to narrow the width of the sensor part 11 at a certain cycle in the x direction in FIG. 1. The width of the sensor part 11 may also be set at an arbitrarily value in the range within which the resolution as a touch sensor is maintained, and the width of the dummy part 12 (the length of the dummy part 12 in the y direction in FIG. 1) and the shape thereof may be set accordingly.

In the present invention, the sensor part and/or the dummy part is formed of a metal mesh pattern formed of repetition of a unit pattern area having a random mesh pattern. Hereinafter, the unit pattern area having a random mesh pattern used in the optically transparent conductive material of the present invention will be described. The mesh pattern used in the present invention includes the following type (a), type (b), and type (c). The use of any one of these mesh patterns gives a random mesh pattern of the sensor part and/or the dummy part, in a unit pattern area having a certain area dimension.

### <a: Voronoi Diagram Type>

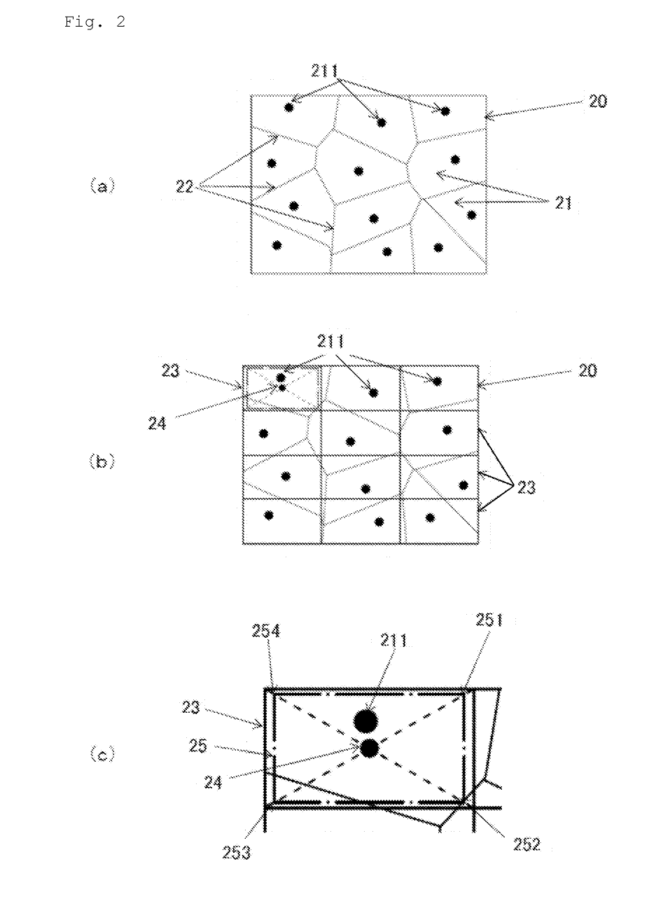

The most preferable mesh pattern used in the present invention is a Voronoi diagram (type a). The Voronoi diagram is a publicly known diagram applied in various fields including the field of information processing. FIG. 2 is used to illustrate the diagram. In FIG. 2a, generators 211 are arranged on a plane 20, and the plane 20 is divided by boundary lines 22 separating a region 21 closest to a generator 211 from other regions each closest to a different generator 211. The boundary lines 22 each between two different regions 21 are called Voronoi edges, and the diagram formed of the Voronoi edges is called a Voronoi diagram.

In the Voronoi diagram type of the present invention, in a graphic formed by tiling of a plane using polygons, each polygon has only one generator arranged in the polygon. Also, the generator is located at an arbitrary position within a reduced polygon formed by connecting points at 90% of the direct distance from the center of gravity of the polygon to each vertex of the polygon. FIGS. 2b and 2c are figures for illustrating the method of arranging the generators, and hereinafter will be used for the purpose. In FIG. 2b, the plane 20 is tiled using twelve quadrangles 23 without any space therebetween, and in each quadrangle 23, one generator 211 is arranged in a random manner. Here, quadrangles are used as polygons, but triangles or hexagons may be used instead. Also, two or more kinds of polygons or polygons of different sizes may be used. However, it is particularly preferable that the tiling of the plane is performed using polygons of a single kind and uniform size. The length of one side of the polygon is preferably 100 to 2000 μm, and more preferably 150 to 800 μm. As shown in FIG. 2c, the generator 211 is located at an arbitrary position within a reduced quadrangle 25 as a reduced polygon formed by connecting points 251, 252, 253, and 254 on straight lines (shown as dashed lines) connecting the center of gravity 24 of the quadrangle 23 and each vertex of the quadrangle 23, the points being located at 90% of the distance from the center of gravity 24 to each vertex. In the present invention, the Voronoi edge is preferably a straight line but may be a curved line, a wavy line, a zigzag line, etc. unless the basic shape of the Voronoi diagram is significantly altered.

### <b: Non-Periodic Tiling Diagram Type>

A different mesh pattern used in the present invention may be a non-cyclic tiling diagram (type b) formed by non-periodic tiling of a plane using polygons. The method used for non-periodic tiling of a plane using polygons may be a publicly known method. Such publicly known methods include, for example, the method using a Penrose tiling devised by Roger Penrose, in which method two kinds of rhombuses, i.e., a rhombus having an acute angle of 72° and an obtuse angle of 108° and a rhombus having an acute angle of 36° and an obtuse angle of 144° are used in combination; a method for non-periodic tiling of a plane using a square, a equilateral triangle, and a parallelogram having angles of 30° and 150°; and a method for non-periodic tiling of a plane using a “girih” pattern used as a design in the medieval Islamic world. Each side in the non-periodic tiling diagram is preferably a straight line but may be a curved line, a wavy line, a zigzag line, etc. unless the basic shape of the diagram is significantly altered. The length of the longest side (in the cases where a wavy line or a curved line is used, the distance between vertices is regarded as the side) of the sides of all the polygons used in the non-periodic tiling of a plane is not more than ⅓ of the cycle (the cycle in the y-direction in FIG. 1) of the sensor parts. The length of the longest side is preferably 100 to 1000 μm, and more preferably 150 to 500 μm.

### <c: Random Mesh Type>

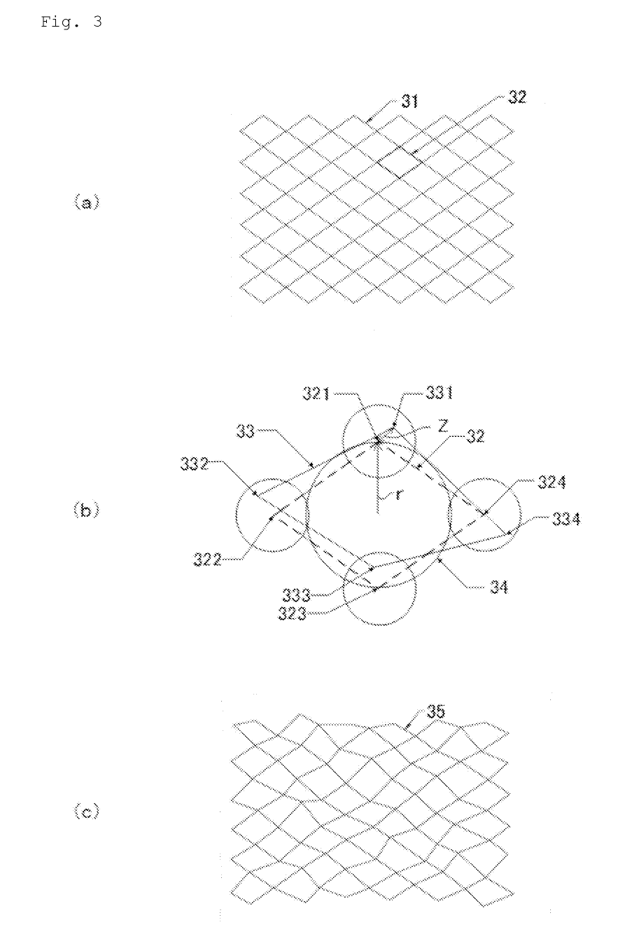

Another mesh pattern used in the present invention may be a random mesh (type c) formed by randomly moving the vertices of a commonly used regular mesh. Hereafter, the random mesh will be illustrated using FIG. 3. In the present invention, the graphic before the vertices are randomly moved is called an original graphic, which corresponds to the original graphic 31 in FIG. 3a. The original graphic 31 is formed of repetition of an original unit graphic 32 (shown by the thick line for the illustrative purposes). The original unit graphic 32 may be of any known shape and examples thereof include triangles, such as an equilateral triangle, an isosceles triangle, and a right triangle; quadrangles, such as a square, a rectangle, a rhombus, a parallelogram, and a trapezoid; n-sided polygons, such as a hexagon, an octagon, a dodecagon, and an icosagon; a circle; an ellipse; and a star. In the present invention, an original graphic formed by repetition of one kind of original unit graphic having any of these shapes, or an original graphic formed by combining two or more kinds of original unit graphics may be used. Also, the brick pattern as disclosed in JP 2002-223095 A may also be used. In the present invention, the original graphic may have any of these patterns, but is preferably formed of repetition of a square or a rhombus, and more preferably formed of repetition of a rhombus having an acute angle of 30 to 70°. The length of one side of the original unit graphic 32 is preferably 1000 μm or less, and more preferably 150 to 500 μm.

Hereafter, the method for moving the vertices from their original positions in an original graphic will be described. In FIG. 3b, an original unit graphic 32 is shown by dashed lines. By moving each of the four vertices 321, 322, 323, and 324 of the original unit graphic 32 in an arbitrary direction and then connecting the moved vertices 331, 332, 333, and 334, a new unit graphic 33 shown by solid lines is formed. In the present invention, the movement distance Z between a vertex of the original unit graphic 32 and the corresponding vertex of the new unit graphic 33 (for example, the movement distance z between the vertex 321 and the vertex 331) is less than ½ of the distance r between the center of gravity of the original unit graphic 32 and the vertex closest to the center of gravity of the original unit graphic 32. In order to illustrate this relation, in FIG. 3b, circles centering on the four vertices 321, 322, 323, and 324 of the original unit graphic 32 are shown. The radius of these circles is equal to ½ of the distance r between the center of gravity of the original unit graphic 32 and the vertex closest to the center of gravity of the original unit graphic 32. Accordingly, the vertices of the new unit graphic 33 (vertices 331, 332, 333, and 334 in the figure) are located within the circles. In FIG. 3b, vertices 321 and 323 are on a circle 34 having a radius equivalent to the distance from the center of gravity of the original unit graphic 32 to the vertex closest to the center of gravity of the original unit graphic 32, and hence (vertices 321 and 323) are the vertex closest to the center of gravity of the original unit graphic 32.

Moving the vertices of the original unit graphic 32 in the above-described manner and then connecting the moved vertices results in the graphic shown in FIG. 3c, which is an example of the mesh pattern of type c used in the present invention. In the random mesh 35 shown in FIG. 3c, 81 vertices (96%) of 84 vertices (intersections) of the original graphic 31 have been moved from their original positions. Thus, in the present invention, it is allowable that some intersections remain at the same positions as in the original graphic. However, at least 50% (in the number), preferably 75% or more of the intersections have been moved from their positions in the original graphic. The mesh of the random mesh 35 is preferably formed of straight lines but may be formed of curved lines, wavy lines, zigzag lines, etc. unless the basic shape of the new unit graphic is significantly altered.

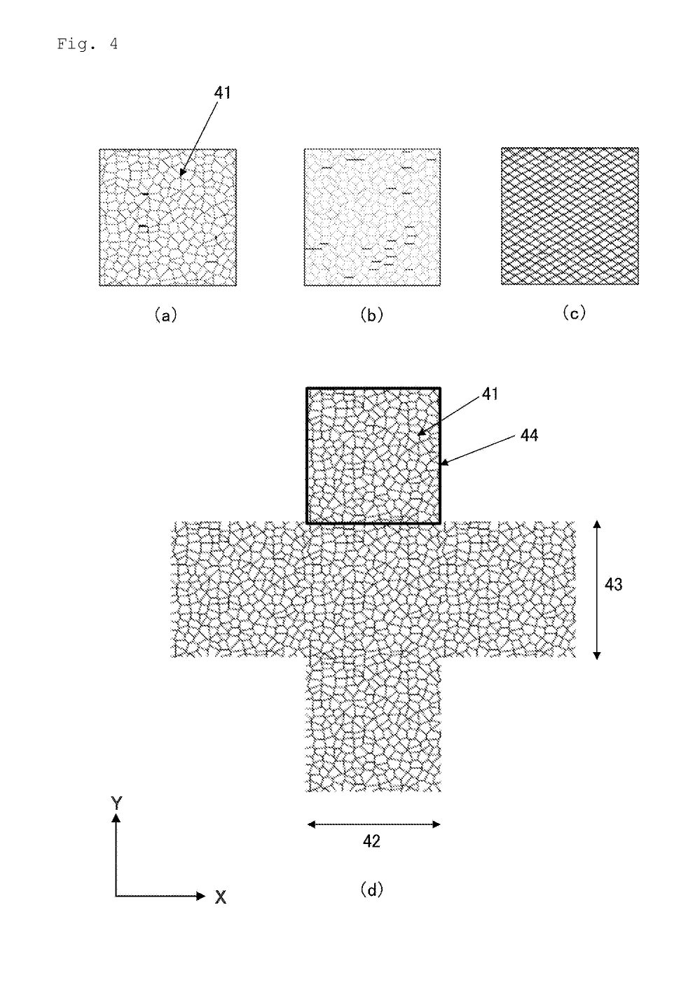

In the present invention, the sensor part 11 and the dummy part 12 in FIG. 1 are each formed of repetition of a unit pattern area having any of the above-described mesh patterns of type a, type b, and type c in the plane of the optically transparent conductive layer. FIG. 4 is a schematic view for illustrating the unit pattern area. FIGS. 4a, 4b, and 4c are examples of the unit pattern areas having the mesh patterns of type a, type b, and type c, respectively. For example, FIG. 4d is an example of the repetition of the unit pattern area 41 having the mesh pattern of type a. The mesh pattern of the unit pattern area 41 has a random pattern not having any cycle within the unit pattern area enclosed by the outline 44. This unit pattern area 41 (having the length 42 in the x direction and the length 43 in the y direction) is repeated at a repetition cycle 42 in the x direction and at a repetition cycle 43 in the y direction to form a large continuous metal pattern. In the cases where the unit pattern area having a random mesh pattern is repeated in this way, metal thin lines on the boundary between two unit pattern areas adjacent to each other may not connect, which may result in line breaks. To avoid such line breaks, in particular in the sensor part 11, the positions of the metal thin lines on the outline 44 of the unit pattern area 41 are preferably corrected for appropriate connection of the metal thin lines in the adjacent unit pattern areas.

In FIG. 4d, the square unit pattern area 41 is repeated in two directions perpendicular to each other in the plane of the optically transparent conductive layer to form the sensor part 11 and the dummy part 12. As long as tiling of a plane can be achieved using the unit pattern area, the outline shape is not particularly limited, and the examples thereof include triangles, such as an equilateral triangle, an isosceles triangle, and a right triangle; quadrangles, such as a square, a rectangle, a rhombus, a parallelogram, and a trapezoid; an equilateral hexagon; a combination of two or more of these and other shapes, etc. Regarding the direction of the repetition, at least two directions in the plane of the optically transparent conductive layer can be selected depending on the outline shape of the unit pattern area. In the present invention, as shown in FIG. 4d, the sensor part 11 and the dummy part 12 are preferably formed by the repetition of the unit pattern area having a square outline shape in two directions perpendicular to each other in the plane of the optically transparent conductive layer.

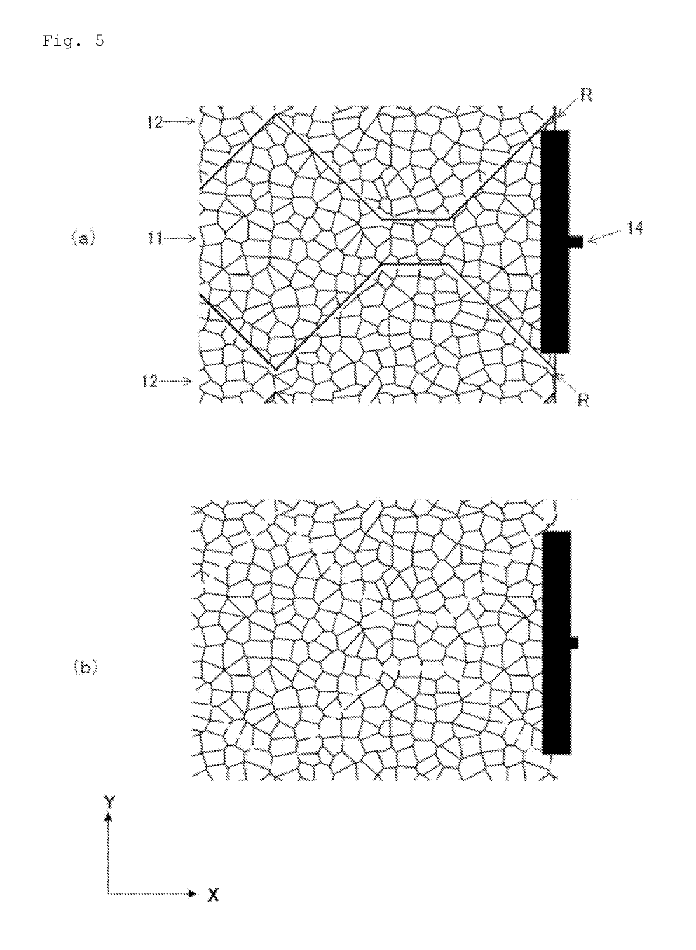

As already described in the description of FIG. 1, there is no electrical connection between the sensor part and the dummy part. FIG. 5 gives an illustration. In FIG. 5a, the sensor part 11 and the dummy part 12 are formed of a metal pattern using a unit pattern area having the mesh pattern of type a, and the sensor part 11 is electrically connected to the peripheral wiring part 14. In FIG. 5a, an imaginary boundary line R is shown on the boundary between the sensor part 11 and the dummy part 12 (the boundary line R does not actually exist), and on the imaginary boundary line R, line breaks are provided to break the electrical connection between the sensor part 11 and the dummy part 12. The length of the line break (the length of the gap between metal thin lines) is preferably 3 to 100 μm, and more preferably 5 to 20 μm. In FIG. 5a, line breaks are provided at positions only along the imaginary boundary line R, but one or more additional line breaks may be provided as needed, for example, in the dummy part. FIG. 5b is a view showing only the actual metal pattern, which is obtained by erasing the imaginary boundary lines R from FIG. 5a.

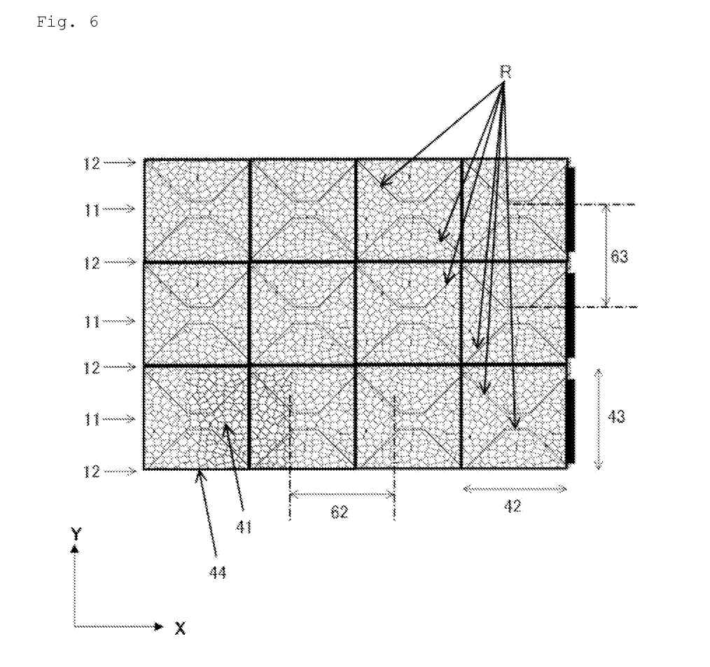

FIG. 6 is a view for illustrating the repetition cycle of the unit pattern area. The sensor part 11 and the dummy part 12 are formed of repetition of a unit pattern area 41 having a random mesh pattern enclosed by the outline 44 (the line shown as the outline 44 is for the illustrative purposes, and does not constitute the metal pattern). An imaginary boundary line R is shown on the boundary between the sensor part 11 and the dummy part 12, and on the imaginary boundary line R, provided are line breaks where the electrical connection between the sensor part 11 and the dummy part 12 is broken. In FIG. 6, the repetition cycle 43 of the unit pattern area 41 in the y direction is the same as the column cycle 63 of the sensor part 11 in the y direction. Regarding the relation between the repetition cycle 43 and the column cycle 63, preferred is that the repetition cycle 43 is equal to an integral multiple of the column cycle 63 or that the column cycle 63 is equal to an integral multiple of the repetition cycle 43, and more preferred is that the column cycle 63 is equal to the repetition cycle 43 as shown in FIG. 6. In addition, the repetition cycle 43 is preferably 1 mm or more, and in the cases where the display element which is joined to the optically transparent electrode to form a touchscreen has a cycle in the y-direction, the repetition cycle 43 is preferably 5 times or more longer than that cycle, and more preferably 10 times or more. The maximum value of repetition cycle 43 is preferably 10 times or less of the column cycle 63.

In FIG. 6, the repetition cycle 42 is the same as the pattern cycle 62 of the sensor part 11 in the x direction. Regarding the relation between the repetition cycle 42 and the pattern cycle 62, preferred is that the repetition cycle 42 is equal to an integral multiple of the pattern cycle 62 or that the pattern cycle 62 is equal to an integral multiple of the repetition cycle 42, and more preferred is that the pattern cycle 62 is equal to the repetition cycle 42. In addition, the repetition cycle 42 is preferably 1 mm or more, and in the cases where the display element which is joined to the optically transparent electrode to form a touchscreen has a cycle in the x-direction, the repetition cycle 42 is preferably 5 times or more longer than that cycle, and more preferably 10 times or more. The maximum value of repetition cycle 42 is preferably 10 times or less of the pattern cycle 62.

Thus far, an optically transparent conductive material which has sensor parts extending in the x direction has been described. In the optically transparent electrode of a capacitive touchscreen, this optically transparent conductive material and an optically transparent conductive material which has sensor parts extending in the y direction are used as a pair in a layered manner, and the sensor parts extending in the y direction are arranged at an arbitrary cycle in the x direction. When the column cycle of the sensor parts extending in the y direction is referred to as “column cycle 64”, the column cycle 64 is preferably equal to the pattern cycle 62 of the sensor parts 11 in FIG. 6. The column cycle 64 is preferably equal to the repetition cycle 42 of the unit pattern area.

In the present invention, the metal pattern constituting the sensor part 11, the dummy part 12, the peripheral wiring part 14, the terminal part 15, etc. in FIG. 1 is preferably made of a metal, in particular, gold, silver, copper, nickel, aluminum, or a composite material thereof. As the method for forming the metal patterns, publicly known methods can be used, and the examples thereof include a method in which a silver halide photosensitive material is used; a method in which, after a silver image is obtained by the aforementioned method, electroless plating or electrolytic plating of the silver image is performed; a method in which screen printing with use of a conductive ink, such as a silver paste and a copper paste, is performed; a method in which inkjet printing with use of a conductive ink, such as a silver ink and a copper ink, is performed; a method in which the metal pattern is obtained by forming a conductive layer by evaporation coating or sputtering, forming a resist film thereon, exposing, developing, etching, and removing the resist layer; and a method in which the metal pattern is obtained by placing a metal foil, such as a copper foil, making a resist film thereon, exposing, developing, etching, and removing the resist layer. Among them, the silver halide diffusion transfer process is preferred for easily forming an extremely microscopic metal pattern and for producing a thinner metal pattern. If the metal pattern produced by any of the above-mentioned procedures is too thick, the subsequent processes may become difficult to carryout, and if the metal pattern is too thin, the conductivity required of touchscreens can hardly be achieved. Therefore, the thickness is preferably 0.01 to 5 μm, and more preferably 0.05 to 1 μm. The line width of the thin lines which form the sensor parts 11 and the dummy parts 12 is preferably 1 to 20 μm, more preferably 2 to 7 μm. The total light transmittance (the total amount of transmitted light, measured according to JIS K7361-1) of the sensor parts 11 and the dummy parts 12 is preferably 80% or more, and more preferably 85% or more. Preferred is that the difference in the total light transmittance between the sensor parts 11 and the dummy parts 12 is within +/−0.1%, and more preferred is that the total light transmittance of the sensor parts 11 is equal to that of the dummy parts 12. The sensor parts 11 and the dummy parts 12 each preferably have a haze value of 2 or less. The b* value (an index of perceivable colors in the yellow direction, specified in JIS Z8730) of the sensor parts 11 and the dummy parts 12 are preferably 2 or less, and more preferably 1 or less.

As the optically transparent base material 2 illustrated in FIG. 1, a publicly known sheet which has optical transparency and which is made of, for example, glass, a polyester resin such as polyethylene terephthalate (PET) or polyethylene naphthalate (PEN), an acrylate resin, an epoxy resin, a fluororesin, a silicone resin, a polycarbonate resin, a diacetate resin, a triacetate resin, a polyarylate resin, polyvinyl chloride, a polysulfone resin, a polyether sulfone resin, a polyimide resin, a polyamide resin, a polyolefine resin, a cyclic polyolefin resin, or the like. Here, “optically transparent” means that the total light transmittance is 60% or higher. The thickness of the optically transparent base material 2 is preferably 50 μm to 5 mm. Also, the optically transparent base material 2 may be provided with a publicly known layer, such as an antifingerprint layer, a hard coat layer, an antireflection layer, and an antiglare layer.

The optically transparent conductive material of the present invention may be provided with, in addition to the optically transparent conductive layer described above, a publicly known layer, such as a hard coat layer, an antireflection layer, an adhesive layer, and an antiglare layer at any location. Also, between the optically transparent base material and the optically transparent conductive layer, a publicly known layer, such as a physical development nuclei layer, an easily adhering layer, and an adhesive layer may be provided.

### Examples

Hereinafter, the present invention will be illustrated in more detail by Examples, but the present invention is not limited thereto and can be embodied in various ways within the technical scope of the invention.

### <Optically Transparent Conductive Material 1>

As an optically transparent base material, a 100-μm-thick polyethylene terephthalate film was used. The total light transmittance of this base material was 91%.

Next, in accordance with the following formulation, a physical development nuclei coating liquid was prepared, applied onto the optically transparent base material, and dried to provide a physical development nuclei layer.

### <Preparation of Palladium Sulfide Sol>

| | | | |
|---|---|---|---|
| Liquid A | Palladium chloride | 5 | g |
| | Hydrochloric acid | 40 | mL |
| | Distilled water | 1000 | mL |
| Liquid B | Sodium sulfide | 8.6 | g |
| | Distilled water | 1000 | mL |

Liquid A and Liquid B were mixed with stirring for 30 minutes, and then passed through a column filled up with an ion exchange resin to give a palladium sulfide sol.

<Preparation of Physical Development Nuclei Coating Liquid> per m² of silver halide photosensitive material

| | | |
|---|---|---|
| The above-prepared palladium sulfide sol | 0.4 | mg |
| 2 mass % glyoxal aqueous solution | 0.2 | mL |
| Surfactant (S-1) | 4 | mg |
| Denacol EX-830 | 50 | mg |
| (Polyethylene glycol diglycidyl ether made by Nagase | | |
| Chemtex Corp.) | | |
| 10 mass % SP-200 aqueous solution | 0.5 | mg |
| (Polyethyleneimine made by Nippon Shokubai Co., Ltd.; | | |
| average molecular weight: 10,000) | | |

Subsequently, an intermediate layer, a silver halide emulsion layer, and a protective layer, of which the compositions are shown below, were applied in this order (from closest to the optically transparent base material) onto the above physical development nuclei layer, and dried to give a silver halide photosensitive material. The silver halide emulsion was produced by a general double jet mixing method for photographic silver halide emulsions. The silver halide emulsion was prepared using 95 mol % of silver chloride and 5 mol % of silver bromide so as to have an average particle diameter of 0.15 μm. The obtained silver halide emulsion was subjected to gold and sulfur sensitization using sodium thiosulfate and chloroauric acid by the usual method. The silver halide emulsion obtained in this way contained 0.5 g of gelatin per gram of silver.

### <Composition of Intermediate Layer Per m² of Silver Halide Photosensitive Material>

| | | |
|---|---|---|
| Gelatin | 0.5 | g |
| Surfactant (S-1) | 5 | mg |
| Dye 1 | 5 | mg |

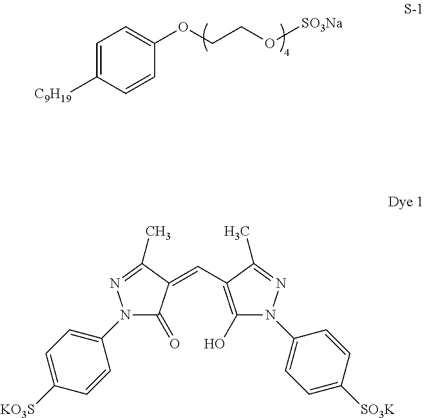

### <Composition of Silver Halide Emulsion Layer Per m² of Silver Halide Photosensitive Material>

| Gelatin | 0.5 | g |
|---|---|---|
| Silver halide emulsion | Equivalent of | |
| | 3.0 g of silver | |
| 1-Phenyl-5-mercaptotetrazole | 3 | mg |
| Surfactant (S-1) | 20 | mg |

### <Composition of Protective Layer Per m² of Silver Halide Photosensitive Material>

| | |
|---|---|
| Gelatin | 1 g |
| Amorphous silica matting agent | 10 mg |
| (average particle diameter: 3.5 μm) | |
| Surfactant (S-1) | 10 mg |

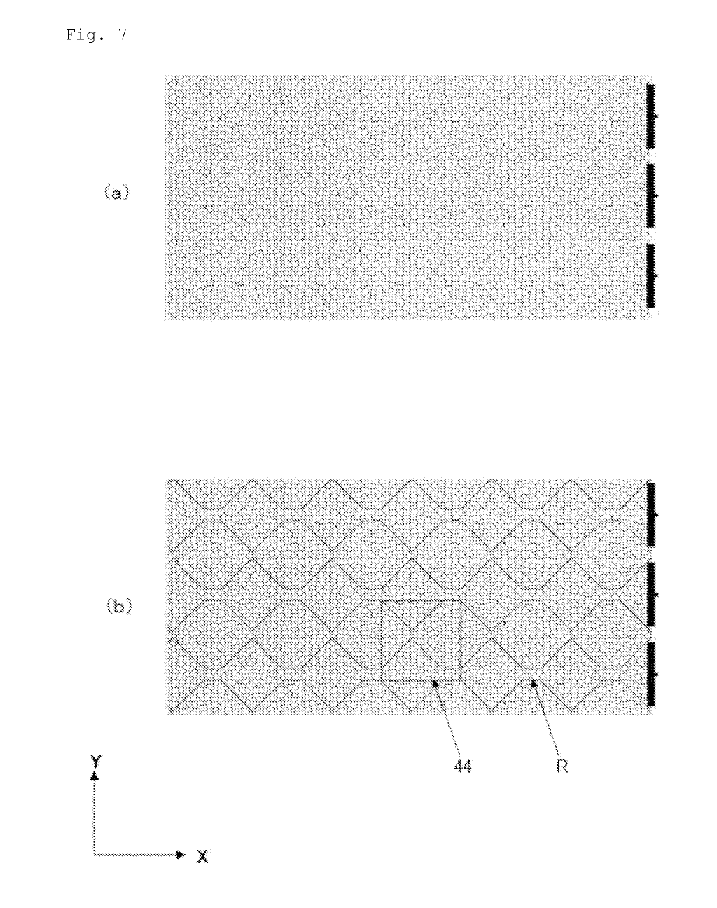

The silver halide photosensitive material obtained as above was brought into close contact with a transparent manuscript having the pattern image shown in FIG. 1, and exposure was performed, through a resin filter which cuts off light of 400 nm or less, using a contact printer having a mercury lamp as a light source. FIG. 7a is an enlarged view showing apart of the transparent manuscript. FIG. 7b is a view obtained by adding imaginary boundary lines R between the sensor parts and the dummy parts and an outline 44 of a unit pattern area for easy understanding (these lines do not actually exist). In the transparent manuscript, the repetition cycle of the unit pattern area in the x direction is 5 mm, which is equal to the pattern cycle of the sensor part in the x direction, and the repetition cycle of the unit pattern area in the y direction is 5 mm, which is equal to the column cycle of the sensor part in the y direction. The mesh pattern constituting the unit pattern area is type a, which is a Voronoi diagram. The plane is tiled using rectangles of which the length of the x-direction side is 0.6 mm and the length of the y-direction side is 0.4 mm, and in each rectangle, a reduced rectangle is formed by connecting points located at 80% of the distance from the center of gravity of the rectangle to each vertex. The generators of the Voronoi diagram are randomly arranged in such a manner that each of the reduced rectangles has one generator therein. The line width of the thin lines forming the mesh pattern is 4 μm. Thin lines on the boundary (shown by imaginary boundary line R) between the sensor parts and the dummy parts are provided with line breaks 20 μm in length. The total light transmittance of the sensor parts is 89.5%, and the total light transmittance of the dummy parts is 89.5%.

After immersion in the diffusion transfer developer shown below at 20° C. for 60 seconds, the silver halide emulsion layer, the intermediate layer, and the protective layer were washed off with warm water at 40° C., and a drying process was performed. In this way, the optically transparent conductive material 1 having a metal silver image having the pattern of FIG. 1 was obtained as an optically transparent conductive layer. The metal silver image of the optically transparent conductive layer of the obtained optically transparent conductive material had the exactly same shape and line width as those of the image of the transparent manuscript having the pattern of FIG. 1 and FIG. 7a. The film thickness of the metal silver image measured with a confocal microscope was 0.1

### <Composition of Diffusion Transfer Developer>

| | |
|---|---|
| Potassium hydroxide | 25 g |
| Hydroquinone | 18 g |
| 1-Phenyl-3-pyrazolidone | 2 g |
| Potassium sulfite | 80 g |
| N-methylethanolamine | 15 g |
| Potassium bromide | 1.2 g |

Water was added to the above ingredients to make the total volume of 1000 mL, and the pH was adjusted to 12.2.

### <Optically Transparent Conductive Material 2>

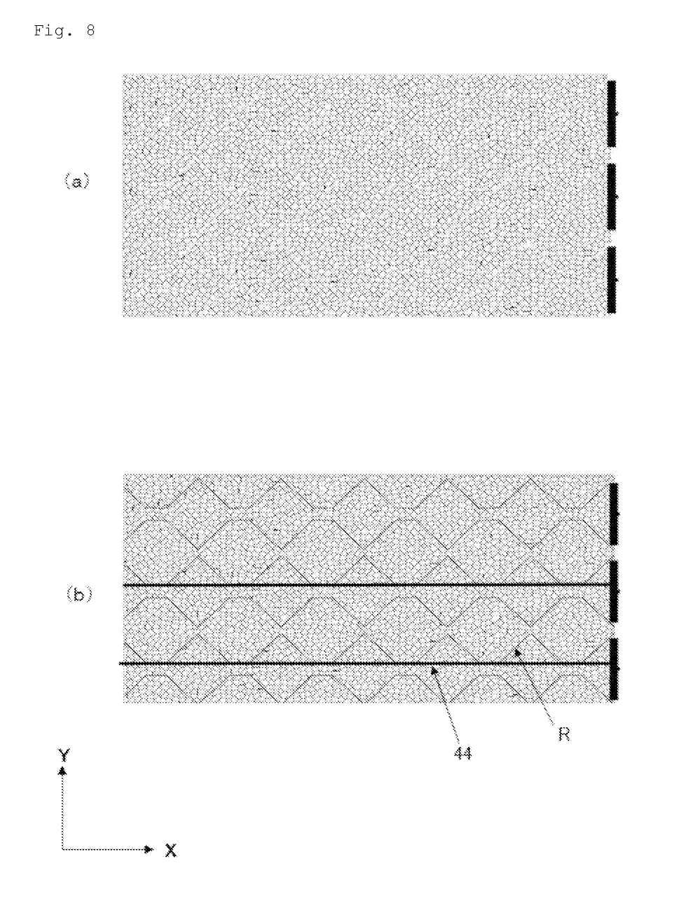

The same procedure was performed as in the preparation for the optically transparent conductive material 1 except for using a transparent manuscript having the pattern of FIG. 1 and FIG. 8 (partial enlarged view), and the optically transparent conductive material 2 was obtained. FIG. 8a is a partial enlarged view of an actual optically transparent conductive material, and FIG. 8b is a view obtained by adding imaginary boundary lines R and an outline 44 of a unit pattern area for easy understanding. The relation between the two figures is the same as in FIG. 7. As shown in FIG. 8b, the unit pattern area used here has a 5-mm repetition cycle in the y-direction, which is the same as the pattern cycle of the sensor part in the x-direction, but does not have any pattern cycle in the x-direction (therefore, the outline 44 is shown only by the lines extending in the x direction). The Voronoi diagram is created in the same manner as in the creation of that for the optically transparent conductive material 1, and the line width of the thin lines forming the mesh pattern, and the total light transmittance of the sensor parts and the dummy parts are the same as those of the optically transparent conductive material 1.

### <Optically Transparent Conductive Material 3>

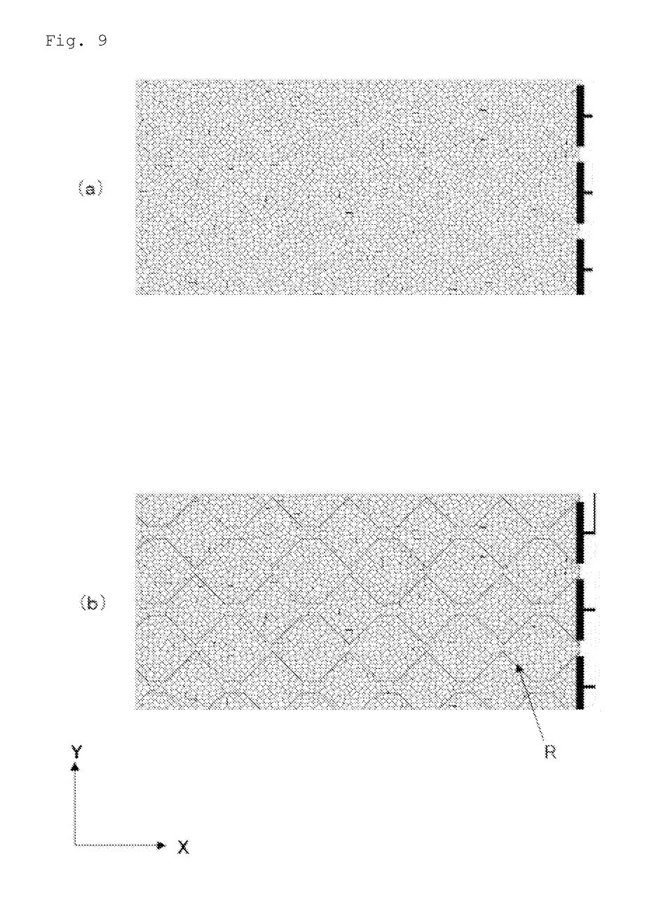

The same procedure was performed as in the preparation for the optically transparent conductive material 1 except for using a transparent manuscript having the pattern of FIG. 1 and FIG. 9 (partial enlarged view), and the optically transparent conductive material 3 was obtained. FIG. 9a is a partial enlarged view of an actual optically transparent conductive material, and FIG. 9b is a view obtained by adding imaginary boundary lines R for easy understanding. The relation between the two figures is the same as in FIG. 7. In FIG. 9b, there is no outline of the unit pattern area shown. This means that the pattern of the optically transparent conductive material 3 does not have any unit pattern area. The metal pattern of the optically transparent conductive material 3 does not have repetition of a pattern in the x-direction or the y-direction. The Voronoi diagram is created in the same manner as in the creation of that for the optically transparent conductive material 1, and the line width of the thin lines forming the mesh pattern, and the total light transmittance of the sensor parts and the dummy parts are the same as those in Example 1.

### <Optically Transparent Conductive Material 4>

The same procedure was performed as in the preparation for the optically transparent conductive material 1 except for using a transparent manuscript which has the pattern of FIG. 1 and, instead of a Voronoi diagram, a mesh pattern formed by repetition of a rhombic unit graphic having a 500-μm diagonal in the x-direction and a 260-μm diagonal in the y-direction, and the optically transparent conductive material 4 was obtained. The line width of the thin lines forming the mesh pattern is 4 μm, and the total light transmittance of the sensor parts and the dummy parts is 89.3%.

### <Optically Transparent Conductive Material 5>

The same procedure was performed as in the preparation for the optically transparent conductive material 1 except for using a transparent manuscript which has the pattern of FIG. 1 and, instead of a Voronoi diagram, the mesh pattern of type b, and the optically transparent conductive material 5 was obtained. The mesh pattern is of a Penrose tiling shown in FIG. 4b, in which a rhombus having an acute angle of 72°, an obtuse angle of 108°, and the length of each side of 350 μm and a rhombus having an acute angle of 36°, an obtuse angle of 144°, and the length of each side of 350 μm are combined. The line width of the thin lines forming the mesh pattern is 4 μm, and the total light transmittance of the sensor parts and the dummy parts is 89.5%.

### <Optically Transparent Conductive Material 6>

The same procedure was performed as in the preparation for the optically transparent conductive material 1 except for using a transparent manuscript which has the pattern of FIG. 1 and, instead of a Voronoi diagram, the mesh pattern of type c, and the optically transparent conductive material 6 was obtained. The mesh pattern is the random mesh pattern shown in FIG. 4c obtained as follows. A rhombic original unit graphic having a 500-μm diagonal in the x-direction and a 260-μm diagonal in the y-direction was repeated to form an original graphic, and the intersections in the original graphic (the vertices of the original unit graphics) were arbitrarily moved. Regarding the intersections on the outline, the movement distance from their positions in the original graphic was 0, and the rest of the intersections were moved in such a manner that each movement distance was less than ½ of the distance between the center of gravity of the original unit graphic and the closest vertex of the original unit graphic. As a result, a mesh pattern in which 303 intersections (84.9%) of the 357 intersections in the unit pattern area were moved from their original positions in the original graphic was obtained. The line width of the thin lines forming the mesh pattern is 4 μm, and the total light transmittance of the sensor parts and the dummy parts is 89.1%.

The obtained optically transparent conductive materials 1 to 6 were evaluated in terms of the visibility and the reliability (stability of resistance). The results are shown in Table 1. The obtained optically transparent conductive material was placed on the screen of a 23″ wide LCD monitor (Flatron23EN43V-B2 made by LG Electronics) displaying solid white, and the visibility was evaluated based on the following criteria. The level at which moire and grain was obvious was defined as “C”, the level at which the boundary was noticeable as a result of close inspection was defined as “B”, and the level at which the boundary was unnoticeable was defined as “A”. For the evaluation of reliability (stability of resistance), each optically transparent conductive material was left in the environment of a temperature of 85° C. and a relative humidity of 95% for 600 hours, then the continuity between all the pairs of terminal parts 15 in FIG. 1 supposed to be electrically connected with each other was checked, and the disconnection rate was determined.

TABLE 1

| | | Reliability | |
|---|---|---|---|
| | | (Disconnection | |
| | Visibility | rate) | Note |
| Optically transparent | A | 0% | Present invention |
| conductive material 1 | | | |
| Optically transparent | C | 60% | Comparative |
| conductive material 2 | | | Example |
| Optically transparent | B | 60% | Comparative |
| conductive material 3 | | | Example |
| Optically transparent | C | 10% | Comparative |
| conductive material 4 | | | Example |
| Optically transparent | B | 0% | Present invention |
| conductive material 5 | | | |
| Optically transparent | B | 10% | Present invention |
| conductive material 6 | | | |

Table 1 shows that the present invention can provide an optically transparent conductive material which has a favorably low visibility of moire and grain even when placed over a liquid crystal display and which has an excellent reliability (stability of resistance).

### REFERENCE SIGNS LIST

1 Optically transparent conductive material
2 Optically transparent base material
11 Sensor part
12 Dummy part
13 Non-image part
14 Peripheral wiring part
15 Terminal part
20 Plane
21 Region
22 Boundary line
23 Quadrangle
24 Center of gravity
25 Reduced quadrangle
31 Original graphic
32 Original unit graphic
33 New unit graphic
41 Circle having a radius equivalent to the distance from the center of gravity of the original unit graphic to the vertex closest to the center of gravity
35 Random mesh
41 Unit pattern area
42, 43 Repetition cycle
44 Outline
62 Pattern cycle
63 Column cycle
211 Generator
251, 252, 253, 254 Point located at 90% of the distance from the center of
R gravity

1. An optically transparent conductive material having, on an optically transparent base material, sensor parts electrically connected to terminal parts and dummy parts not electrically connected to the terminal parts, the conductive material being characterized in that in the plane of the optically transparent conductive layer, the sensor parts are formed of a plurality of column electrodes extending in a first direction, the plurality of column electrodes being arranged at an arbitrary cycle in a second direction perpendicular to the first direction in such a manner that each dummy part is sandwiched between every two of the sensor parts, and that the sensor parts and/or the dummy parts are formed of a metal pattern in which a unit pattern area having any of the following mesh patterns (a) to (c) is repeated in at least two directions in the plane of the optically transparent conductive layer;
(a) a mesh pattern consisting of Voronoi edges formed in relation to a plurality of points (generators) arranged in a plane tiled using polygons, the mesh pattern being characterized in that each polygon has only one generator arranged in the polygon, and the generator is at an arbitrary position within a reduced polygon formed by connecting points at 90% of the direct distance from the center of gravity of the polygon to each vertex of the polygon;
(b) a mesh pattern formed by non-periodic tiling of a plane using polygons, the mesh pattern being characterized in that the length of the longest side of all the sides of all the polygons is not more than ⅓ of the cycle of the sensor part in the second direction; and
(c) a mesh pattern obtained by moving 50% or more of all the intersections in an original graphic formed of repetition of an original unit graphic consisting of a polygon (50% or more of all the vertices of the original unit graphics) in a direction, the mesh pattern being characterized in that the distance between the original position of an intersection before the move and the position of the intersection after the move is less than ½ of the distance from the center of gravity of the original unit graphic to the closest vertex of the original unit graphic.

2. The optically transparent conductive material of claim 1, characterized in that the repetition cycle of the unit pattern area in the second direction is equal to an integral multiple of the column cycle in the second direction, of the column electrodes extending in the first direction; or the column cycle in the second direction, of the column electrodes extending in the first direction is equal to an integral multiple of the repetition cycle of the unit pattern area in the second direction.

3. The optically transparent conductive material of claim 1, characterized in that the repetition cycle of the unit pattern area in the first direction is equal to an integral multiple of the pattern cycle in the first direction, of the column electrodes extending in the first direction; or the pattern cycle in the first direction, of the column electrodes extending in the first direction is equal to an integral multiple of the repetition cycle of the unit pattern area in the first direction.

4. The optically transparent conductive material of claim 2, characterized in that the repetition cycle of the unit pattern area in the first direction is equal to an integral multiple of the pattern cycle in the first direction, of the column electrodes extending in the first direction; or the pattern cycle in the first direction, of the column electrodes extending in the first direction is equal to an integral multiple of the repetition cycle of the unit pattern area in the first direction.
